(19) United States
(12) Patent Application Publication
(10) Pub. No.: US 2008/0077553 A1
(43) Pub. Date: Mar. 27, 2008

(54) DYNAMIC REPRIORITIZATION OF SEARCH ENGINE RESULTS

(76) Inventors: Sivakumar Jambunathan, Round Rock, TX (US); Indran Naick, Cedar Park, TX (US); Cheranellore Vasudevan, Austin, TX (US)

Correspondence Address: IBM CORP (YA);C/O YEE & ASSOCIATES PC, P.O. BOX 802333, DALLAS, TX, 75380, US

(21) Appl. No.: 11/534,304

(22) Filed: Sep. 22, 2006

(51) Int. Cl. G06F 17/30

(52) U.S. Cl. 707/2

(57) ABSTRACT

A computer implemented method and computer program product for reprioritizing the search results of a search engine. A user, using a search engine performs an initial search. The search engine ranks and displays the search results to the user. The user then accesses one or more links displayed on the page. The improved search engine infers additional information from the links accessed on the displayed page. Based upon the inferred information, the improved search engine reprioritizes the remaining search results.

### BACKGROUND OF THE INVENTION

1. Field of the Invention

The present invention relates generally to an improved data processing system, and in particular, to a computer implemented method and computer program product for dynamically reprioritizing search engine results based upon information inferred from the links accessed by the search engine user.

2. Description of the Related Art

Internet search engines are special sites on the Web that are designed to find information stored on other Web sites. There are various internet search engines (hereinafter search engines) all operating in somewhat different ways. The power of a search engine to sift through volumes of data across networks and retrieve information is enormous. A simple keyword search returns hundreds of pages of results in seconds. However, the usefulness of the results returned is an issue. The large set of results that closely match the keywords and indexes pose the difficulty of how to prioritize the search results. Determining what is of interest to the user is vital to the usefulness of the search engine.

Most search engines perform three basic tasks. They search the internet for important words, build an index of the words, and allow users to look for words or combinations of words in the index. Different search engines organize their indexes differently and use different algorithms to rank the search results. Therefore, the same keyword inquiry, input into different search engines, display different search results, often with many of the same links presented in a different order. The user must then sort through pages of search results looking for the links of interest.

### SUMMARY OF THE INVENTION

The illustrative embodiments described herein provide a computer implemented method and computer program product for reprioritizing the search results of a search engine. A user, using a search engine performs an initial search. The search engine ranks and displays the search results to the user. The user then accesses one or more links displayed on the page. The improved search engine infers additional information from the links accessed on the displayed page. Based upon the inferred information, the improved search engine reprioritizes the remaining search results.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 shows a block diagram of a data processing system in which illustrative embodiments may be implemented; and

FIG. 3 is a flow chart of a process for reprioritizing the search results of a search engine in accordance with the illustrative embodiments.

### DETAILED DESCRIPTION OF THE PREFERRED EMBODIMENT

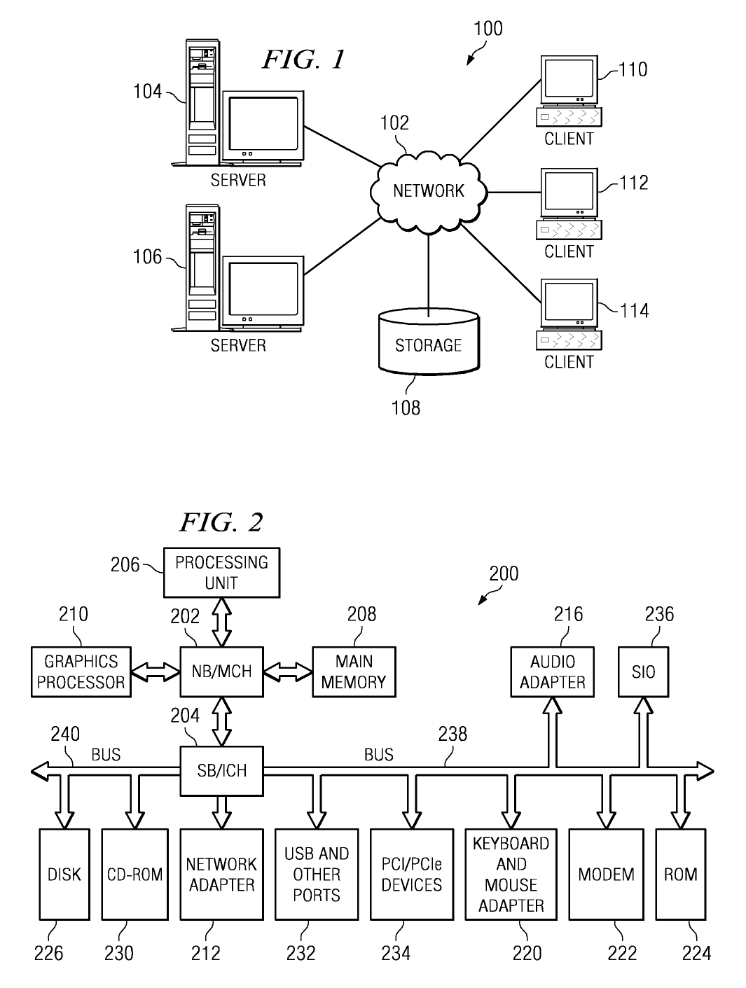

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft Windows XP (Microsoft and Windows are trademarks of Microsoft Corporation in the United States, other countries, or both). An object oriented programming system, such as the Java programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

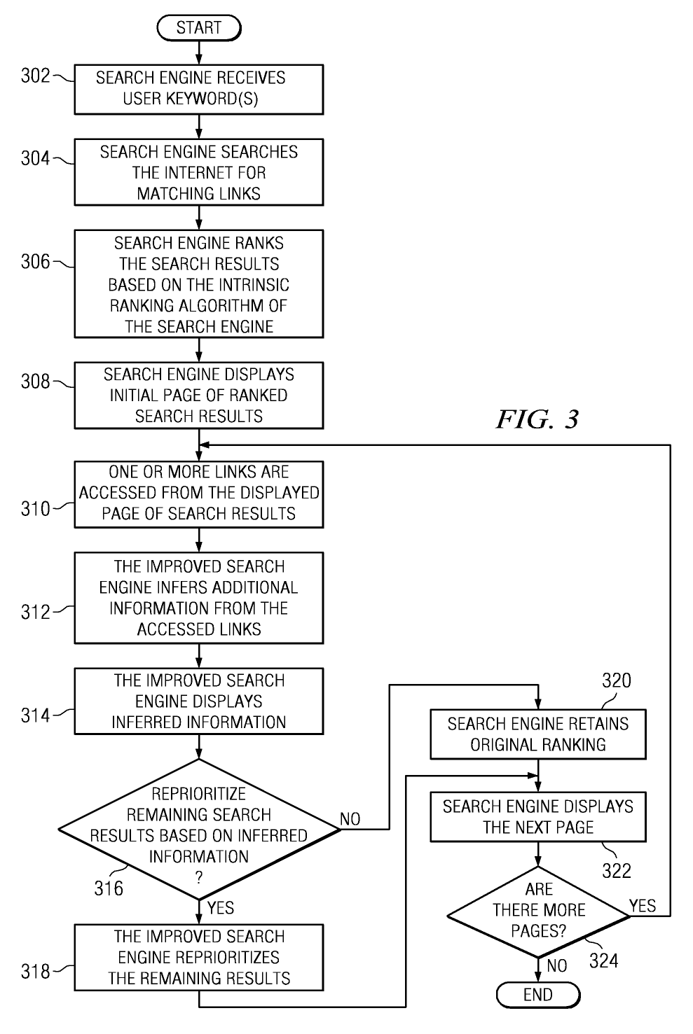

FIG. 3 is a flow chart of a process for reprioritizing a search result in accordance with the illustrative embodiments. The process depicted in FIG. 3 may be implemented in a data processing system, such as data processing system 200 in FIG. 2. The process begins when the search engine receives a keyword or keywords from the user (step 302). The search engine may also receive a Boolean expression. The search engine accesses the search index to match the keywords and develop a list of links that have some probability of interest to the user (step 304). The search engine then ranks the links in the search results according to the intrinsic algorithm used by the search engine (step 306), placing the links with higher probability of interest towards the beginning of the search results. An intrinsic algorithm is an algorithm used by the search engine independent of the improved search engine. The search engine then displays the initial page of ranked search results to the user (step 308). The user may then access one or more Web sites by clicking on links from the display page of the search result (step 310). If the user does not select any links during the viewing of the search result, there is no further information with which the improved search engine may reprioritize the remaining search results. Therefore, if the user does not select any links, the improved search engine retains the previous search result ranking.

Next, according to the illustrative embodiments, the improved search engine infers additional information from the Web page(s) of the links accessed by the user (step 312). To infer additional information the improved search engine may use common keywords found within the Web page(s) accessed. The improved search engine may also use a commonality in the metadata of the selected sites to reprioritize the search results. Metadata is data a Web page master identifies as a description of the Web page. The inferred information is the information gathered from the links accessed by the user, whether the information is composed of keywords, metadata or a combination of the two.

The improved search engine displays the inferred information to the user (step 314). The inferred information may be displayed to the user, as keywords or Boolean expressions, in a dialogue box similar to the dialogue box in which the user initially queried the search engine. The user determines whether to reprioritize the remaining search results based on the inferred information (step 316). In one embodiment, the improved search engine may automatically reprioritize the search result, without user input. In another embodiment, the improved search engine may give the user the opportunity to edit the inferred information and then accept a reprioritization of the search results based on the edited inferred information. In this example however, the user may accept a reprioritization of the search results (step 318), or reject the reprioritization of the search results (step 320). If the user opts to reject the reprioritization of the search results, the improved search engine retains the original ranking of the search result.

If the user opts to accept a reprioritization of the search results (step 318), the remaining search result is reprioritized based on the inferred information. A remaining search result comprises search results that have not been viewed by the user. The improved search engine may reprioritize the search results by using the inferred common keywords from the selected links. The most common keyword may be given the highest weight. The next most common keyword may be given the next highest weight and so forth, giving a weight to all of the common keywords found in the links accessed by the user. The reprioritization of the remaining search results may then be based upon the sum of the weighted keywords. This reprioritization will cause the links that are most similar to the links the user already selected to appear at the beginning of the reprioritized search results.

The common metadata associated with the accessed links may be given a weight, similarly to the keyword method described above, and compared to the remaining search results. The improved search engine may then reprioritize the search results by comparing the remaining search results to the weighted metadata. Again the improved search engine may use a combination of keywords and metadata to reprioritize the remaining search results.

The improved search engine may use the intrinsic ranking algorithm of the search engine to reprioritize the search result, based on the inferred information. An intrinsic ranking algorithm is the method the search engine uses to rank the links in the search result. In other words, an intrinsic ranking algorithm is the native prioritization method of the search engine. Alternatively, in another illustrative embodiment, the improved search engine may use an extrinsic ranking algorithm. An extrinsic ranking algorithm is an algorithm different from the intrinsic ranking algorithm of the search engine. In other words, an extrinsic ranking algorithm is not used in the initial ranking process by the search engine, but is used in the reprioritization process by the improved search engine. In yet another embodiment, the improved search engine may use a combination of an intrinsic and extrinsic algorithm to reprioritize the search results.

The search engine displays the next unviewed page (step 322). The next unviewed page may be reprioritized or retain the original search result ranking, based on the selection the user made in step 316. The improved search engine then determines if there are more pages in the search result (step 324). If yes, there are more pages in the search result, the improved search engine returns to step 310 and infers further information from the links selected by the user. If no, there are no more pages in the search result, the process ends.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for reprioritizing search results from a search engine comprising:
responsive to a user selecting links from a search result, inferring additional information, to form inferred information;
reprioritizing the search result, based on the inferred information; and
displaying the search result in a reprioritized order.

2. The computer implemented method of claim 1 further comprising:
presenting the user with the inferred information; and
responsive to a confirmation from the user, displaying the search result in the reprioritized order.

3. The computer implemented method of claim 2 further comprising:
allowing the user to edit the inferred information, to form edited inferred information;
reprioritizing the search result, based on the edited inferred information; and
responsive to a confirmation from the user, displaying the search result in the reprioritized order.

4. The computer implemented method of claim 1, wherein the search result is reprioritized based on one of an intrinsic ranking algorithm, an extrinsic ranking algorithm, or a combination of an intrinsic and extrinsic ranking algorithm.

5. A computer program product for reprioritizing search results from a search engine, the computer program product comprising:
a computer usable medium having computer usable program code tangibly embodied thereon, the computer usable program code comprising:
computer usable program code for inferring additional information, to form inferred information, responsive to a user selecting links from a search result;
computer usable program code for reprioritizing the search result, based on the inferred information; and
computer usable program code for displaying the search result in a reprioritized order.

6. The computer program product of claim 5 further comprising:
computer usable program code presenting the user with the inferred information; and
computer usable program code displaying the search result in the reprioritized order, responsive to a confirmation from the user.

7. The computer program product of claim 6 further comprising:
computer usable program code allowing the user to edit the inferred information, to form edited inferred information;
computer usable program code reprioritizing the search result, based on the edited inferred information; and
computer usable program code displaying the search result in the reprioritized order, responsive to a confirmation from the user.

8. The computer program product of claim 5, wherein the search result is reprioritized based on one of an intrinsic ranking algorithm, an extrinsic ranking algorithm, or a combination of an intrinsic and extrinsic ranking algorithm.
